(19) United States
(12) Patent Application Publication
(10) Pub. No.: US 2012/0031210 A1
(43) Pub. Date: Feb. 9, 2012

(54) RACK ARRANGEMENT FOR UNDERGROUND WINNING INSTALLATIONS AND BEARING BRACKET THEREFOR

(75) Inventors: Siegfried Schmidt, Bottrop (DE); Jorg Wirtz, Witten (DE)

(73) Assignee: BUCYRUS EUROPE GMBH, Lunen (DE)

(21) Appl. No.: 13/260,636

(22) PCT Filed: Mar. 18, 2010
(86) PCT No.: PCT/IB10/51177

§ 371 Date: Sep. 27, 2011

(30) Foreign Application Priority Data
Apr. 1, 2009 (DE) 20 2009 002 021.5

(51) Int. Cl. E21C 29/02; F16M 13/02

(52) U.S. Cl. 74/89.17; 248/224.8

(57) ABSTRACT

A rack arrangement for underground winning installations having bearing brackets being fastenable at pan sections of a face conveyor and which have two pin holes each, and having rack bars being detachably fastenable to the pin holes of adjacent bearing brackets via pin connections having connecting pins. In order to design the rack arrangement and the bearing bracket for easier fitting and to improve the interplay between bearing bracket and rack bars in operational use, both pin holes are designed as an elongated hole for accommodating the connecting pin 7.

The invention relates to a rack arrangement for underground winning installations, comprising bearing brackets which can be fastened to pan sections of a face conveyor of the underground winning installation and have two pin holes each, and comprising rack bars which can be detachably fastened at the pin holes of adjacent bearing brackets via pin connections having connecting pins. The invention also relates to bearing brackets for such a rack arrangement of an underground winning installation, wherein the bearing bracket has two pin holes, at which rack bars can be detachably fastened by means of cylindrical pins which engage in the pin holes.

### BACKGROUND OF THE INVENTION

A rack arrangement of the type in question is known from DE 203 08 996 U1. The rack arrangement serves to advance a shearer loader which is provided with a travel drive, is guided along the face conveyor and meshes, by means of a drive sprocket, with rack teeth in sections of the rack bars in order to move the shearer loader back and forth reversibly in each case between the face ends. A multiplicity of rack bars are laid in a row along the face in order to form a rack with which the shearer loader can be buttressed over the entire travel path. In this case, every individual rack bar is supported with coupling extensions in bearing brackets which are welded to side cheeks of the conveyor usually at regular distances apart. Each pan section normally contains two bearing brackets, such that a rack bar is laid between two bearing brackets, while two further rack bars project beyond each end of the pan section and are supported with their other end on the next bearing bracket of the adjacent pan section. Since the individual pan sections are connected to one another in such a way as to allow angular movement, it is known in each case to make one of the holes in the bearing bracket or in the coupling extension of the rack bars as an elongated hole in order to also compensate for the play with regard to the rack bars overlapping the pan section joint, thereby enabling the rack arrangement to follow the curved course of the face conveyor more effectively.

### SUMMARY OF THE INVENTION

An object of the invention is to design the rack arrangement and the bearing bracket for easier fitting and to improve the interplay between bearing bracket and rack bars in operational use.

This object and others are achieved according to the invention in that both pin holes are designed as an elongated hole for movably and/or possibly eccentrically accommodating the cylindrical connecting pin, which engages in said holes in the fitted state. In the solution according to the invention, incorrect fitting of a bearing bracket can no longer take place since each bearing bracket has from the outset two pin holes designed as elongated holes, and only one mould is required for producing all the bearing brackets, which are of identical construction. At the same time, the possible play along the entire rack arrangement is improved since all the rack bars can receive sufficient play at both ends or since all the rack bars could be movably mounted on the pan sections. At the same time, the play available overall is increased and in this respect improves the angular mobility of individual pan sections relative to one another, as a result of which possibly even smaller curve radii than hitherto can be made possible.

In a rack arrangement, it is especially advantageous if, as known per se, the rackbars are provided with downwardly pointing coupling extensions close to both bar ends, wherein each coupling extension can be pushed into a pocket formed on the bearing bracket and is provided with a round hole for putting the connecting pin through. To achieve the advantages according to the invention, it is not absolutely necessary for all the bearing brackets to have two elongated holes as pin holes and other bearing brackets can also be used here and there . However, it is in particular advantageous if all the rack bars have coupling extensions with round holes and all the bearing brackets have two pin holes designed as elongated holes each. In addition, it is not necessary for all the connecting pins to sit movably in the elongated holes during operational use, but rather the play could also be varied by adapting the distance between the associated round holes in the coupling extensions or could even be prevented if, for example, the distance between the round holes on the rack bars corresponds only to the minimum distance between the flanks, lying adjacent to one another, of the elongated holes of two successive bearing brackets.

With regard to both the rack arrangement and the bearing bracket it might also be advantageous if the bearing bracket, according to a preferred configuration according to the invention, is provided with an at least upwardly open pocket between a bracket base and a bracket front web. The pocket is preferably open both upwards and downwards. In order to achieve reliable mounting of the rack bars on the bearing brackets, the bracket front web is preferably integrally connected to the bracket base via side webs. Furthermore, in order to be able to compensate for tilting moments, it is advantageous if the bracket front web projects at least partly higher than the bracket base. The bracket base can in particular increase in height from the side flanks to a central section and then preferably has a flat top side in the region of the central section. This measure gives the bearing bracket a relatively deep pocket overall, with acceptable use of material. The entire bracket base preferably extends downwards in a projecting manner, as a result of which a cavity is formed below the central section, said cavity preferably being open to the rear and being defined at the sides by prolongation sections of the side webs. The opening of the cavity toward the rear permits especially easy removal of inserted cylindrical or connecting pins. Furthermore, the widening of the bearing bracket by the centre section, which projects rearwards starting from the pocket, makes it possible for the bearing bracket to be connected, in particular welded, with the rear side directly to a spill plate or angle plate of the goaf-side side cheek.

In an especially preferred configuration, an intermediate wall defining the pocket and provided with the elongated holes is formed between cavity and pocket, said intermediate wall preferably reaching down to the bottom of the bearing bracket, wherein a transverse web is integrally formed at the base between intermediate wall and bracket front web and is arranged centrally and below the two elongated holes in order to design the bearing bracket overall as a torsion- and bending-resistant element of small size and low overall weight. Alternatively, the intermediate wall can at the same time also form the rear wall of the bearing bracket, and the projecting prolongation can be dispensed with.

Further advantages and configurations of a rack arrangement according to the invention and of a bearing bracket according to the invention follow from the description below of preferred exemplary embodiments shown in the drawings.

Further, these and other objects, aspects, features, developments and advantages of the invention of this application will become apparent to those skilled in the art upon a reading of the Detailed Description of Embodiments set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which form a part hereof and wherein:

FIG. 1 schematically shows a detail of a rack arrangement according to the invention in a partial side view of an only intimated face conveyor;

FIG. 2 schematically shows, in a perspective view, the top end of a side cheek of a pan section having two bearing brackets according to the invention, with rack bars omitted;

FIG. 3 shows a bearing bracket according to the invention in detail in a perspective view from above and the front;

FIG. 4 shows the bearing bracket from FIG. 3 in a perspective view from below and the rear;

FIG. 5 shows the fastening of a rack bar to the bearing bracket in a sectional view through a pin connection; and

FIG. 6 shows a bearing bracket according to the invention in an alternative exemplary embodiment in a perspective view from above and the front.

### DETAILED DESCRIPTION OF EMBODIMENTS

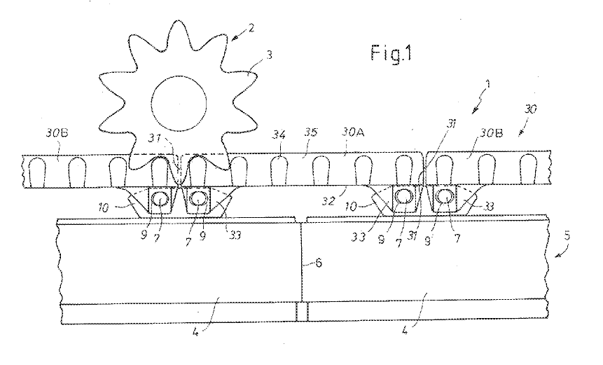

Referring now to the drawings wherein the showings are for the purpose of illustrating preferred and alternative embodiments of the invention only and not for the purpose of limiting same, FIG. 1 schematically shows, in a highly simplified manner, a detail of an underground winning apparatus 1, in particular for mining coal. The underground winning apparatus 1 comprises, inter alia, a shearer loader, of which only the drive sprocket 2 of a travel drive is shown schematically in FIG. 1. The teeth 3 of the drive sprocket 2, the tooth flanks of which are of arched design like a cycloidal tooth system, mesh with a rack bar which is designated overall by 30 and consists of individual rack bars 30A, 30B which are fastened successively in a row to the pan sections 4 of a face conveyor 5 (only shown schematically). As known, the individual pan sections 4 are connected to one another in a manner resistant to tension but in such a way as to be movable at an angle to a limited extent in the horizontal and vertical. The length of the rack bars 30A, 30B is in each case shorter than the length of the individual pan sections 4, the rack bar 30A overlapping the pan section joint 6 between two adjacent pan sections 4, whereas the two adjoining rack bars 30B each extend only over part of the same pan section 4. The rack bar 30A and the rack bar 30B each have a sturdy supporting strip 35 supporting the rack teeth 34, and these supporting strips 35 are provided with downwardly pointing, sturdy coupling extensions 33 which fixedly adjoin both bar ends 31 below the underside 32 and are secured via cylindrical connecting pins 7 in bearing brackets 10 which are fastened, preferably welded, to the pan sections 4. As can already be readily seen from FIG. 1, the bearing bracket 10 for the pin connection to the coupling extension 33 on the rack bar 30A and also to the coupling extension 33 on the rack bar 30B has a respective elongated hole 9, as pin hole, which extends with the longer axis in the axial direction of the rack bar 30, whereas the through-holes, formed in the coupling extensions 33 on the rack bars 30A, 30B, for the connecting pins 7 are all designed as preferably circular round holes. All the rack bars 30A, 30B are therefore secured with play at the elongated holes 9 of the bearing brackets 10. The play achieved with the elongated holes 9 is sufficient for the entire rack 30, in particular the individual rack bars 30A, 30B, to be able to compensate for or follow the horizontal and vertical angular movements of the pan section 4 at the pan section joint 6.

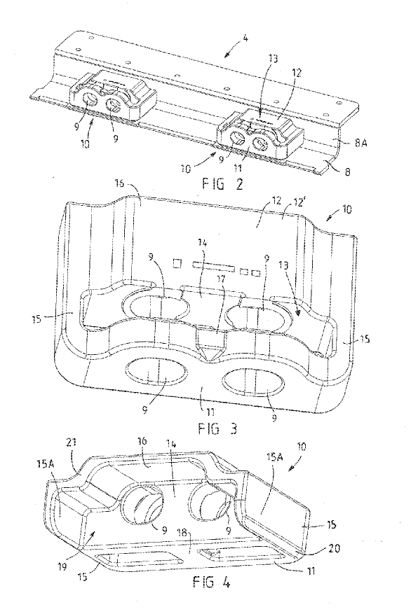

Of a pan section 4, FIG. 2 shows only an angle plate 8, which in a pan section 4 forms the top terminating element of the goaf-side side cheek and to which the two bearing brackets 10 for supporting the rack bars for this pan section 4 are fastened, in particular welded around the circumference. Since the rack bars are not shown in FIG. 2, it can be seen especially clearly that, at both bearing brackets 10, in each case both pin holes consist of horizontal elongated holes 9. Each bearing bracket 10 has, between a bracket front web 11 and a bracket base 12, a pocket 13 into which the coupling extensions (33, FIG. 1) of the rack bars are inserted in order to then movably connect the rack bars and bearing brackets using the connecting pins.

Reference will now first be made to FIGS. 3 and 4, in which a bearing bracket 10 is shown in detail in a preferred configuration according to the invention. The bearing bracket 10 preferably consists of a cast part having a sturdy, relatively wide bracket base 12 and a relatively narrow bracket front web 11, wherein, for the pin connection using the connecting pins, each elongated hole 9 is formed both in the bracket front web 11 and in a vertically oriented intermediate wall 14 running parallel to the bracket front web 11. The pocket 13 is therefore defined on the one side by the intermediate wall 14 and on the other side by the bracket front web 11, the bracket front web 11 being integrally connected to the bracket base 12 via side webs 15. The bearing bracket 10 has a considerably smaller height in the region of the side webs 15 than in the region of a central section 16 of the bracket base 12 or of a corresponding section on the bracket front web 11, the horizontal elongated holes 9 each being arranged in this region of greater height. In the central section 16, which extends rearwards in a projecting manner from the intermediate wall, the bearing bracket 10 has a flat surface 12′, whereas the bracket front web 11 is provided centrally with a niche 17 between both elongated holes 9. As can readily be seen in particular from FIG. 4, the intermediate wall 14 and the bracket front web 11 are connected to one another not only via the two side webs 15 but also via a transverse web 18 arranged at the bottom in order to additionally stiffen the pocket 13 for accommodating the coupling extensions. As FIG. 4 also readily shows, the bearing bracket 10 has a cavity 19 below the central section 16 and to the rear of the intermediate wall 14, said cavity 19 being defined laterally by the prolongation sections 15A, which in turn have a smaller height, of the side webs 15 and being open to the rear. The prolongation sections 15A, the side webs 15 and the bracket front web 11 are provided at the bottom with an encircling bevel 20 in order to be able to weld the bearing bracket 10 at the bottom, except at the open rear side, to the bottom leg of the angle plate (8, FIG. 2), also in an encircling manner, via a continuous weld.

The rear prolongation of the bearing bracket 10, said prolongation being produced by the central section 16, which projects relatively far rearwards, preferably by about two to four times the width of the pocket 13, enables the bearing bracket 10, directly with its rear side 21, to also be welded to the vertically projecting leg section 8A of the angle plate 8 (FIG. 2) and to fit closely there at the same time. This fastening situation is shown in detail in FIG. 5, to which reference will now be made. Of a pan section 4, FIG. 5 again shows substantially only the angle plate 8 fastened to the goaf-side side cheek 4A and the bearing bracket 10 welded to the angle plate 8. A correspondingly dimensioned coupling extension 33 of a rack bar 30 is inserted into the pocket 13 between the intermediate wall 14 and the bracket front web 11, and, for fastening the rack bar 30 to the bearing bracket 10, the connecting pin 7 passes through the elongated holes 9, in alignment with one another, in the bracket front web 11 and in the intermediate wall 14 and also through the round hole 36 in the coupling extension 33 positioned between said bracket front web 11 and said intermediate wall 14. The connecting pin 7 has multiple steps and is sufficiently long to reach through the cavity 19 below the central section 16, prolonging the bracket 10 rearwards, and to also reach with a pin end 7A through an aperture 45 in the upwardly projecting leg section 8A of the angle plate 8 in such a way that the connecting pin 7 can be secured in the pin connection position thereof against falling out or release by means of pin locking elements 40 of virtually any desired configuration. FIG. 5 also readily shows that the bracket front leg 11, at least partly with the front web top side 11′ thereof, projects higher than the top side 12′ of the central section 16 and that the rack bar 30 rests with the underside thereof, in the fitted state, partly on the front web top side 11′ in order to absorb the tilting moment as favorably as possible on the bearing bracket 10 when a shearer loader passes through.

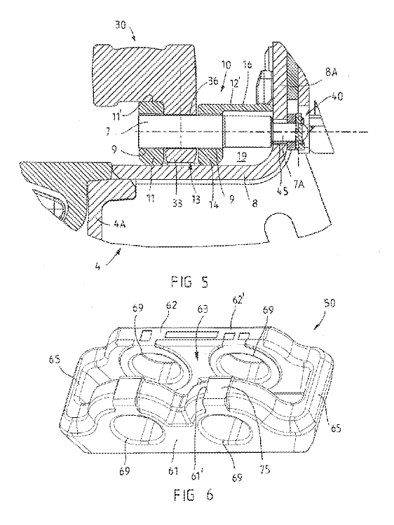

FIG. 6 shows a second exemplary embodiment according to the invention of a bearing bracket 50. As in the previous exemplary embodiment, the bearing bracket 50 has a bracket base 62 and a bracket front web 61 which are connected at the margins via side webs 65 and between which a pocket 63 is formed into which two respective coupling extensions of adjacent rack bars can be inserted. Here, the bracket base 62 consists of a wall web, the thickness of which is equal to or slightly smaller than that of the bracket front web 62. Here, too, both pin holes in the bracket front web 61 are again designed according to the invention as elongated holes 69, and the pin holes, in alignment with the latter, in the wall web forming the bracket base 62 are also designed as elongated holes 69. The top side 61′ of the bracket front web 61 is provided with a narrow support web 75, and at least this support web 75 projects higher than the top side 62′ of the bracket base 62. In order to then also weld the bracket base 62 to the upwardly projecting section of an angle plate, an intermediate plate must be welded in place between the wall web forming the bracket base 62 and the angle plate, for which reason the exemplary embodiment in FIGS. 1 to 5 has numerous further advantages over this configuration.

For the person skilled in the art, numerous modifications which are to come within the scope of protection of the attached patent claims emerge from the above description. The invention is not restricted to the exemplary embodiments shown. The distance between the round holes of those rack bars which are fastened between two bearing brackets fastened to the same pan section can also be selected in such a way that the connecting pins sit eccentrically in the elongated holes and therefore little or no play of these rack bars relative to the bearing brackets is allowed. To this end, the distance between the round holes is preferably the same size as the minimum distance between the flanks, lying adjacent to one another, of the elongated holes of two successive bearing brackets.

Further, while considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-10. (canceled)

11. A rack arrangement for underground winning installations, the rack arrangement comprising bearing brackets being fastenable at pan sections of a face conveyor and which include two pin holes each, and the arrangement further comprising rack bars being detachably fastenable to the pin holes of adjacent bearing brackets via pin connections having connecting pins, both pin holes are designed as an elongated pin hole for accommodating the connecting pin.

12. The rack arrangement according to claim 11, wherein the rack bars are provided with downwardly pointing coupling extensions close to the bar ends, wherein each coupling extension is pushable into a pocket formed in the bearing bracket and the couple extension is provided with a round hole for putting the connecting pin through.

13. The rack arrangement according to claim 12, wherein all the rack bars have the coupling extensions having the round holes, and all the bearing brackets have the two pin holes designed as elongated pin holes each.

14. The rack arrangement according to claim 11, wherein the bearing brackets are provided with an at least upwardly open pocket between a bracket base and a bracket front web.

15. The rack arrangement according to claim 14, wherein the bracket front web is integrally connected to the bracket base via side webs.

16. The rack arrangement according to claim 14, wherein the bracket front web projects at least partly higher than the bracket base.

17. The rack arrangement according to claim 14, wherein the bracket base increases in height from the side flanks to a central section and has a flat top side in the region of the central section.

18. The rack arrangement according to claim 17, wherein the bracket front web is integrally connected to the bracket base via side webs, the central section projects rearwards and a cavity is formed below the central section, the cavity preferably being open to the rear and being defined at the sides by prolongation sections of the side webs.

19. The rack arrangement according to claim 18, wherein the elongated pin holes are elongated front web pin holes formed between a front face of the bracket front web and the at least upwardly open pocket, the bearing brackets further including an intermediate wall partially defining the at least upwardly open pocket and the intermediate wall provided with elongated intermediate pin holes formed between the cavity and the pocket and the intermediate pin holes being in axial alignment with the front web pin holes, the intermediate wall reaches down toward the bottom of the bearing bracket, wherein a transverse web is formed at least near the base between the intermediate wall and the bracket front web and is arranged centrally between and deeper than the elongated pin holes.

20. The rack arrangement according to claim 11, wherein the elongated pin holes have a short axis and a long axis, the long axis generally extending in the axial direction of the rack bars.

21. A bearing bracket for a rack arrangement of an underground winning installation, the bearing bracket comprising two pin holes, at which associated rack bars are detachably fastenable by connecting pins which are insertable into the pin holes, both pin holes are designed as an elongated hole for accommodating the respective connecting pin.

22. The bearing bracket according to claim 21, wherein the bearing bracket is provided with an at least upwardly open pocket between a bracket base and a bracket front web.

23. The bearing bracket according to claim 22, wherein the bracket front web is integrally connected to the bracket base via side webs.

24. The bearing bracket according to claim 22, wherein the bracket front web projects at least partly higher than the bracket base.

25. The bearing bracket according to claim 22, wherein the bracket base increases in height from the side flanks to a central section and has a flat top side in the region of the central section.

26. The bearing bracket according to claim 25, wherein the bracket front web is integrally connected to the bracket base via side webs, the central section projects rearwards and a cavity is formed below the central section, the cavity preferably being open to the rear and being defined at the sides by prolongation sections of the side webs.

27. The bearing bracket according to claim 26, wherein the elongated pin holes are elongated front web pin holes formed between a front face of the bracket front web and the at least upwardly open pocket, the bearing brackets further including an intermediate wall partially defining the at least upwardly open pocket and the intermediate wall provided with elongated intermediate pin holes formed between the cavity and the pocket and the intermediate pin holes being in axial alignment with the front web pin holes, the intermediate wall reaches down toward the bottom of the bearing bracket, wherein a transverse web is formed at least near the base between the intermediate wall and the bracket front web and is arranged centrally between and deeper than the two elongated pin holes.

28. The bearing bracket according to claim 21, wherein the elongated pin holes have a short axis and a long axis, the long axis generally extending in the axial direction of the associated rack bars.
